(19) United States
(12) Patent Application Publication
(10) Pub. No.: US 2025/0192912 A1
(43) Pub. Date: Jun. 12, 2025

(54) WAVELENGTH REMAPPING IN AN ON-CHIP WAVELENGTH DIVISION MULTIPLEXING (WDM) SOLUTION

(71) Applicant: Lightmatter, Inc., Boston, MA (US)

(72) Inventors: Nikhil Kumar, East Palo Alto, CA (US); Srinivasan Ashwyn Srinivasan, Toronto (CA); Darius Bunandar, Boston, MA (US)

(73) Assignee: Lightmatter, Inc., Boston, MA (US)

(21) Appl. No.: 18/970,617

(22) Filed: Dec. 5, 2024

Related U.S. Application Data
(60) Provisional application No. 63/607,489, filed on Dec. 7, 2023.

(51) Int. Cl. H04J 14/02

(52) U.S. Cl. CPC H04J 14/0227

(57) ABSTRACT

Described herein are architectures configured to enable wavelength remapping in on-chip wavelength division multiplexing (WDM) optical systems. An optical switching network receives light having wavelengths corresponding to wavelength set A at a first subset of the plurality of inputs and light having wavelengths corresponding to wavelength set B at a second subset of the plurality of inputs. The wavelengths are received in accordance with a first spatial order. In response, the optical switching network may change the order from the first spatial order to a second spatial order. For example, the optical switching network may output light having wavelengths corresponding to wavelength set A at a first subset of the plurality of outputs and light having wavelengths corresponding to wavelength set B at a second subset of the plurality of outputs in accordance with the second spatial order.

### CROSS-REFERENCE TO RELATED APPLICATION

This application claims the benefit under 35 U.S.C. § 119(e) of U.S. Provisional Patent Application Ser. No. 63/607,489, entitled “WAVELENGTH REMAPPING IN AN ON-CHIP WDM SOLUTION,” filed on Dec. 7, 2023, under Attorney Docket No. L0858.70085US00, which is hereby incorporated herein by reference in its entirety.

### BACKGROUND

Optical interconnects are a type of communication technology that use light signals to transmit data between different components or devices within a system. These interconnects replace traditional electrical connections, such as copper wires or traces on a circuit board, with optical fibers or waveguides. In optical interconnects, data is converted into light using optical transmitters, typically lasers or light-emitting diodes (LEDs). These optical signals travel through optical fibers or waveguides, which are made of materials that can efficiently guide and transmit light with minimal loss. At the receiving end, optical receivers convert the incoming light signals back into electrical signals that can be processed by electronic devices.

Optical transceivers are devices that transmit and receive data using light signals, typically over optical fiber cables. Optical transceivers play a crucial role in telecommunications and data communication networks, converting electrical signals into optical signals for transmission and then converting them back into electrical signals at the receiving end. Wavelength division multiplexing (WDM) is a technology used in optical communication to transmit multiple signals simultaneously over a single optical fiber. WDM achieves this by using different wavelengths (colors) of light for each signal, allowing for efficient use of the fiber's bandwidth and significantly increasing the data-carrying capacity.

Ring resonator-based WDM transmitters are advanced components used in optical communications to achieve efficient WDM. These devices leverage the properties of ring resonators to filter and control specific wavelengths of light, allowing for the precise manipulation and routing of optical signals in a WDM system. When multiple wavelengths of light are introduced into a waveguide, a ring resonator selectively couples the wavelength that matches its resonant wavelength. This enables it to act as a filter, allowing only the desired wavelength to pass through or be dropped into an adjacent waveguide.

### SUMMARY OF THE DISCLOSURE

Some embodiments relate to a photonic integrated circuit (PIC), comprising: an optical switching network having a plurality of inputs and a plurality of outputs, wherein the optical switching network is configured to, in response to receiving light having wavelengths corresponding to a first wavelength set at a first subset of the plurality of inputs and light having wavelengths corresponding to a second wavelength set at a second subset of the plurality of inputs in accordance with a first spatial order, output light having wavelengths corresponding to the first wavelength set at a first subset of the plurality of outputs and light having wavelengths corresponding to the second wavelength set at a second subset of the plurality of outputs in accordance with a second spatial order, wherein the first spatial order differs from the second spatial order; and a plurality of optical transmitters coupled to the plurality of outputs of the optical switching network, each optical transmitter of the plurality of optical transmitters being configured to encode light received from the respective output with data.

In some embodiments, the plurality of inputs comprise N inputs and the plurality of outputs comprise N outputs.

In some embodiments, the PIC further comprises a first plurality of optical sources and a second plurality of optical sources, each optical source of the first plurality being configured to emit light having wavelengths corresponding to the first wavelength set and each optical source of the second plurality being configured to emit light having wavelengths corresponding to the second wavelength set, wherein the first plurality of optical sources are coupled to the first subset of the N inputs of the optical switching network and the second plurality of optical sources are coupled to the second subset of the N inputs of the optical switching network in accordance with the first spatial order.

In some embodiments, each optical source of the first and second pluralities of optical sources is disposed outside the PIC.

In some embodiments, in the first spatial order, wavelengths corresponding to the first wavelength set and wavelengths corresponding to the second wavelength set are grouped contiguously, and in the second spatial order, wavelengths corresponding to the first wavelength set alternate with wavelengths corresponding to the second wavelength set.

In some embodiments, in the first spatial order, wavelengths corresponding to the first wavelength set alternate with wavelengths corresponding to the second wavelength set, and in the second spatial order, wavelengths corresponding to the first wavelength set and wavelengths corresponding to the second wavelength set are grouped contiguously.

In some embodiments, a first optical transmitter of the plurality of optical transmitters that is coupled to an output of the first subset of the plurality of outputs comprises a first plurality of resonant modulators, each resonant modulator of the first plurality of resonant modulators being tuned to a respective wavelength of the first wavelength set.

In some embodiments, a second optical transmitter of the plurality of optical transmitters that is coupled to an output of the second subset of the plurality of outputs comprises a second plurality of resonant modulators, each resonant modulator of the second plurality of resonant modulators being tuned to a respective wavelength of the second wavelength set.

In some embodiments, the resonant modulators of the first plurality of resonant modulators and the resonant modulators of the second plurality of resonant modulators comprise ring-based resonant modulators.

In some embodiments, the optical switching network comprises a plurality of directional couplers arranged in a plurality of stages including first, second and third stages, wherein the directional couplers of the second stage are coupled to outputs of the directional couplers of the first stage and to inputs of the directional couplers of the third stage.

In some embodiments, the plurality of inputs comprise N inputs and the plurality of outputs comprise N outputs, and wherein the plurality of stages comprise Log₂(N) stages.

In some embodiments, the optical switching network is arranged in accordance with a butterfly architecture.

Some embodiments relate to a photonic integrated circuit (PIC), comprising an optical switching network having N inputs, N outputs, a plurality of directional couplers arranged in a plurality of stages including first, second and third stages, wherein the directional couplers of the second stage are coupled to outputs of the directional couplers of the first stage and to inputs of the directional couplers of the third stage, wherein the plurality of stages comprise Log₂(N) stages, and a plurality of optical transmitters coupled to the N outputs of the optical switching network, each optical transmitter of the plurality of optical transmitters being configured to encode light received from the respective output with data.

In some embodiments, the PIC further comprises a first plurality of optical sources and a second plurality of optical sources, each optical source of the first plurality being configured to emit light having wavelengths corresponding to a first wavelength set and each optical source of the second plurality being configured to emit light having wavelengths corresponding to a second wavelength set, wherein the first plurality of optical sources are coupled to a first subset of the N inputs of the optical switching network and the second plurality of optical sources are coupled to a second subset of the N inputs of the optical switching network in accordance with a first spatial order.

In some embodiments, the plurality of directional couplers are configured to output light having wavelengths corresponding to the first wavelength set at a first subset of the N outputs and light having wavelengths corresponding to the second wavelength set at a second subset of the N outputs in accordance with a second spatial order, wherein the first spatial order differs from the second spatial order.

In some embodiments, in the first spatial order, wavelengths corresponding to the first wavelength set and wavelengths corresponding to the second wavelength set are grouped contiguously, and in the second spatial order, wavelengths corresponding to the first wavelength set alternate with wavelengths corresponding to the second wavelength set.

In some embodiments, a first optical transmitter of the plurality of optical transmitters that is coupled to an output of the first subset of the N outputs comprises a first plurality of resonant modulators, each resonant modulator of the first plurality of resonant modulators being tuned to a respective wavelength of the first wavelength set, and a second optical transmitter of the plurality of optical transmitters that is coupled to an output of the second subset of the N outputs comprises a second plurality of resonant modulators, each resonant modulator of the second plurality of resonant modulators being tuned to a respective wavelength of the second wavelength set.

Some embodiments relate to a a method for operating a photonic integrated circuit (PIC), comprising: using an optical switching network having a plurality of inputs and a plurality of outputs to, in response to receiving light having wavelengths corresponding to a first wavelength set at a first subset of the plurality of inputs and light having wavelengths corresponding to a second wavelength set at a second subset of the plurality of inputs in accordance with a first spatial order, output light having wavelengths corresponding to the first wavelength set at a first subset of the plurality of outputs and light having wavelengths corresponding to the second wavelength set at a second subset of the plurality of outputs in accordance with a second spatial order, wherein the first spatial order differs from the second spatial order; and using a plurality of optical transmitters, coupled to the plurality of outputs of the optical switching network and co-integrated with the optical switching network on the PIC, to encode light received from respective outputs with data.

In some embodiments, the method further comprises using a first plurality of optical sources to emit light having wavelengths corresponding to the first wavelength set and using a second plurality of optical sources to emit light having wavelengths corresponding to the second wavelength set, wherein the first plurality of optical sources are coupled to a first subset of the plurality of inputs of the optical switching network and the second plurality of optical sources are coupled to a second subset of the plurality of inputs of the optical switching network in accordance with the first spatial order.

In some embodiments, in the first spatial order, wavelengths corresponding to the first wavelength set and wavelengths corresponding to the second wavelength set are grouped contiguously, and in the second spatial order, wavelengths corresponding to the first wavelength set alternate with wavelengths corresponding to the second wavelength set.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 is a block diagram illustrating an optical system including an optical switching network, in accordance with some embodiments.

FIG. 2A is a block diagram illustrating the inputs and outputs of an optical switching network, in accordance with some embodiments.

FIG. 2B is a block diagram illustrating how an optical switching network may change the order of wavelength sets received at its inputs, in accordance with some embodiments.

FIG. 2C is a block diagram illustrating the locations of the inputs and the outputs of an optical switching network, in accordance with some embodiments.

FIG. 3 is a block diagram illustrating an example implementation of an optical switching network, in accordance with some embodiments.

FIG. 4 is a block diagram illustrating an example implementation of a transceiver, in accordance with some embodiments.

FIG. 5 is a block diagram of another example of an optical switching network, in accordance with some embodiments.

FIG. 6 is a block diagram of yet another example of an optical switching network, in accordance with some embodiments.

### DETAILED DESCRIPTION

Described herein are architectures configured to enable wavelength remapping in on-chip wavelength division multiplexing (WDM) optical systems. The architectures developed by the inventors and described herein enable arbitrary WDM networks regardless of how the WDM optical sources are spatially arranged relative to one another. Further, these architectures enable arbitrary WDM networks notwithstanding the use of non-tunable optical sources (although tunable optical sources may be used in some embodiments, as the architectures described herein are not incompatible with tunable optical sources). The resulting WDM networks may be used in large-scale settings, such as in networks including more than one hundred nodes or more than one thousands nodes. For example, these optical networks may be used in data centers to facilitate communication among large number of computational units, such as graphical processing units (GPU).

In conventional WDM bidirectional systems, in which a fiber supports traffic of data in two opposite directions, it is common to transmit different wavelength sets in different directions. Consider for example a system including a fiber and a pair of transceivers connected to opposite ends of the fiber and that communicate with each other through the fiber. The system may be configured so that the first transceiver transmits light having wavelengths corresponding to a first set of predefined wavelengths and the second transceiver transmits light having wavelengths corresponding to a second set of predefined wavelengths. Separating the wavelengths in this way prevents interference between data that travel in opposite directions.

The inventors have recognized and appreciated, however, that assigning WDM channels statically in this manner severely constraints the number of possible network topologies. Instead of statically assigning wavelengths in accordance with a predefined scheme, the architectures described herein enable wavelength remapping—a technique by which wavelengths may be assigned to channels arbitrarily depending on the specific needs of the network. For example, in some embodiments, this is accomplished using a transmitter configured to emit light at N distinct wavelengths, and an optical switching network that remaps the emitted wavelengths to wavelengths corresponding to any desired set of predefined wavelengths. Consider an example in which only two wavelength sets are used. The first wavelength set will be referred to as wavelength set A and the second wavelength set will be referred to as wavelength set B (it should be noted, however, that the architectures described herein may be extended to systems including more than two wavelength sets). In this example, the optical switching network can map the N wavelengths emitted by an optical source either to the wavelengths corresponding to the wavelength set A or to the wavelengths corresponding to the wavelength set B. This scheme promotes network flexibility and enables topologies that wouldn't otherwise be practical or possible using conventional WDM static schemes.

Some embodiments are directed to an optical switching network having a plurality of inputs and a plurality of outputs (e.g., N inputs and N outputs). The optical switching network receives light having wavelengths corresponding to wavelength set A at a first subset of the plurality of inputs and light having wavelengths corresponding to wavelength set B at a second subset of the plurality of inputs. The wavelengths are received in accordance with a first spatial order. In the first spatial order, wavelengths corresponding to wavelength set A and wavelengths corresponding to wavelength set B may be grouped contiguously (although other orders are possible). In response, the optical switching network may change the order from the first spatial order to a second spatial order. For example, the optical switching network may output light having wavelengths corresponding to wavelength set A at a first subset of the plurality of outputs and light having wavelengths corresponding to wavelength set B at a second subset of the plurality of outputs in accordance with the second spatial order. In the second spatial order, wavelengths corresponding to wavelength set A may alternate with wavelengths corresponding to wavelength set B (although other orders are possible).

Optical switching networks of the types described herein may be implemented in any of numerous ways. In one example, an optical switching network includes a plurality of directional couplers arranged in a plurality of stages including at least first, second and third stages. The directional couplers of the second stage are coupled to outputs of the directional couplers of the first stage and to inputs of the directional couplers of the third stage. In some embodiments, an optical switching network of this type includes Log₂(N) stages, where N represents the number of inputs or outputs of the optical switching network. For example, an optical switching network having sixteen outputs may include four stages. Each stage remaps the wavelengths received at its input.

In one example, an optical switching network may be implemented using a butterfly architecture. Butterfly architectures of the types described herein include multi-stage networks where signals pass through multiple stages of optical couplers before reaching the destination. Butterfly networks allow multiple optical signals to be routed simultaneously through parallel paths, minimizing interference and increasing throughput. Optionally, a butterfly network employs a recursive structure whereby the network is divided into smaller sub-networks that are interconnected to one another. Butterfly architectures can scale efficiently with an increasing number of inputs and outputs, making them suitable for large-scale optical switching applications.

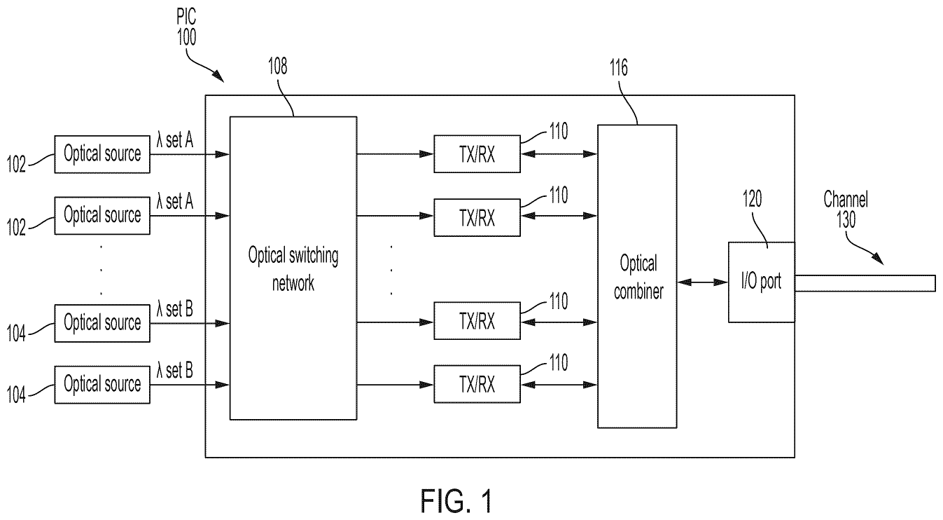

FIG. 1 is a block diagram illustrating an optical system in accordance with some embodiments. The system includes a photonic integrated circuit (PIC) 100, optical sources of a first type (referred to as optical sources 102) and optical sources of a second type (referred to as optical sources 104), and an optical channel 130. PIC 100 includes an optical switching network 108, a plurality of transceivers (TX/RX) 110, an optical combiner 116 and an input/output (I/O) port 120. PIC 100 may be implemented using a semiconductor substrate (e.g., a silicon photonics substrate). As such, the components illustrated in FIG. 1 as being part of PIC 100 may be co-patterned on a common semiconductor substrate.

Optical sources of different types may be configured to emit light having wavelengths corresponding to different wavelength sets. For example, optical sources 102 may emit light having wavelengths corresponding to wavelength set A (identified in FIG. 1 as “λ set A”) and optical sources 104 may emit light having wavelengths corresponding to wavelength set B (identified in FIG. 1 as “λ set B”). Each wavelength set may include any suitable number of wavelengths, including for example between four wavelengths and twelve wavelengths (e.g., eight wavelengths). In one example, wavelength set A includes wavelengths λ₁, λ₂, λ₃, λ₄, λ₅, λ₆, λ₇ and λ₈, and wavelength set B includes λ₉, λ₁₀, λ₁₁, λ₁₂, λ₁₃, λ₁₄, λ₁₅, and λ16. In this example, the wavelengths of sets A and B are grouped contiguously. In another example, wavelength set A includes wavelengths λ₁, λ₃, λ₅, λ₇, λ₉, λ₁₁, λ₁₃, and λ₁₅ wavelength set B includes wavelengths λ₂, λ₄, λ₆, λ₈, λ₁₀, λ₁₂, λ₁₄, and λ₁₆. In this other example, the wavelengths of sets A alternate with the wavelengths of set B. In both examples, a first wavelength having an index (e.g., i+1) that is greater than the index (e.g., i) of a second wavelength indicates that the first wavelength is greater than the second wavelength. Other schemes are also possible. It should be noted that although FIG. 1 illustrates a system having two distinct types of optical sources, more than two distinct types of optical sources are possible. The wavelengths emitted by the optical sources may be in any suitable band, including in the O-band, the S-band, the C-band or the L-band.

Optical sources 102 and 104 may each be implemented using a bank of lasers or light emitting diodes (LED). In some embodiments, the optical sources 102 and 104 may be non-tunable. Accordingly, the wavelengths of emission of each optical source may be fixed. In other embodiments, however, the optical sources 102 and 104 may be tunable and the wavelengths of emission may be varied.

Channel 130 is coupled to I/O port 120 and includes an optical medium configured to support optical communication in two directions. For example, channel 130 may include a fiber (e.g., a single mode fiber) or an optical waveguide formed on a substrate other than PIC 100. I/O port 120 may be implemented in any of numerous ways, including as an edge coupler or an out-of-plane coupler (e.g., a grating coupler or a prism).

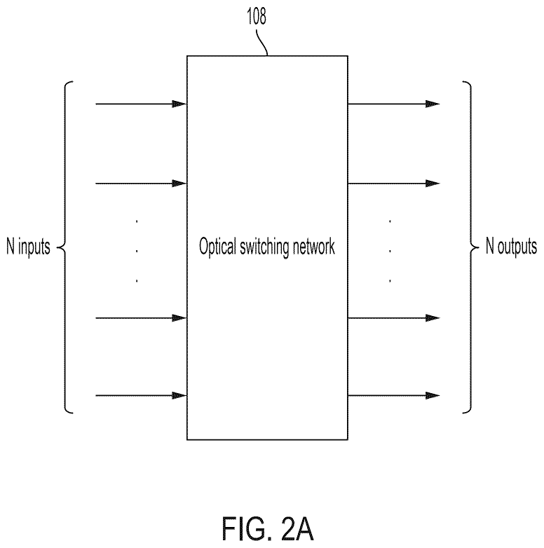

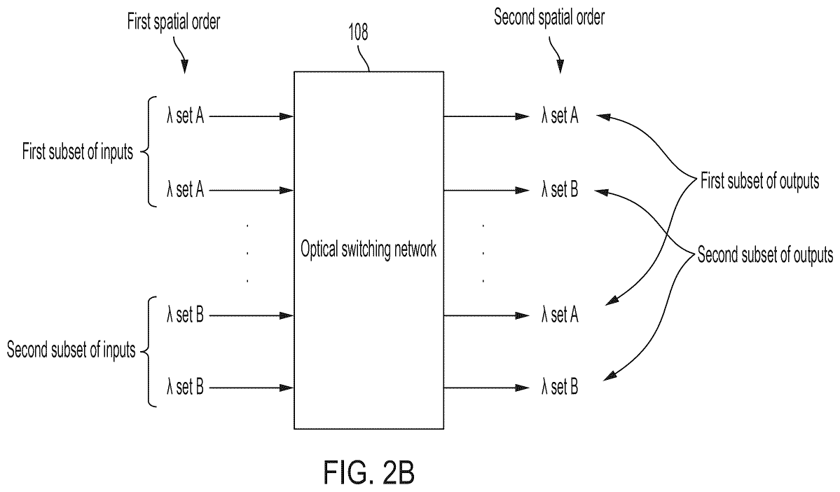

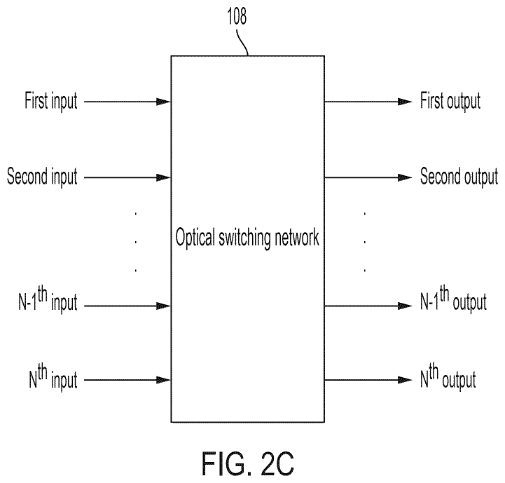

As described in detail in connection with FIGS. 2A-2C, an optical switching network 108 remaps the wavelength sets received at its inputs from a first spatial order to a second spatial order different from the first spatial order at its outputs.

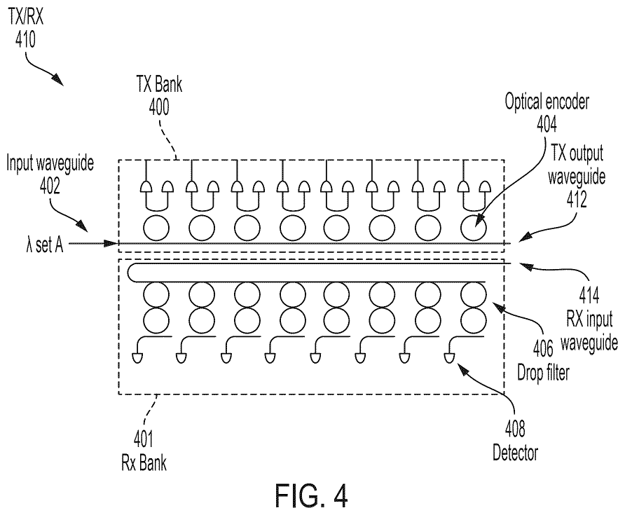

Each transceiver 110 includes a transmitter (TX) and a receiver (RX). An example of a transceiver is described below in connection with FIG. 4. Each transmitter encodes with data light having wavelengths corresponding to the wavelength set provided by the corresponding output of optical switching network 108. For example, each transmitter may include a bank of resonant modulators, each resonant modulators being configured to encode with data light having a wavelength corresponding to a respective wavelength of the set. Other types of transmitters are possible, including Mach Zehnder modulators or Franz-Keldysh modulators.

Light encoded with data using transceivers 110 is ultimately coupled to channel 130 for transmission outside PIC 100, upon passing through optical combiner 116 and I/O port 120. Each receiver is configured to transform encoded light received using channel 130 into the electrical domain. For example, each receiver may include a photodetector and trans-impedance amplifier (TIA). The photodetector transforms the encoded light into a photocurrent, and the TIA transforms the photocurrent into a voltage having a level within the accepted dynamic range of further electronic circuitry (e.g., an analog-to-digital converter).

Optical combiner 116 may include optical circuitry configured to route light in one direction, from the transmitters to channel 130 and, in the opposite direction, from channel 130 to the receivers. In doing so, optical combiner 116 prevents interference between the wavelengths traveling in opposite directions. For example, optical combiner 116 may be designed to promote selective coupling using a combination of constructive interference and destructive interference. Wavelengths that are coupled from the transmitters to the off-chip optical channel thanks to constructive interference do not couple to the receivers because of destructive interference. Similarly, wavelengths that are coupled from the off-chip optical channel to the receivers thanks to constructive interference do not couple to the transmitters because of destructive interference.

FIG. 2A is a block diagram illustrating the inputs and outputs of optical switching network 108. In this example, optical switching network 108 has the same number of inputs and outputs: N. As further shown in FIG. 2B, optical switching network 108 receives light having wavelengths corresponding to wavelength set A at a first subset of the plurality of inputs and light having wavelengths corresponding to wavelength set B at a second subset of the plurality of inputs. Wavelength sets are received at the inputs in accordance with a first spatial order. In the first spatial order of the example of FIG. 2B, wavelengths corresponding to wavelength set A and wavelengths corresponding to wavelength set B are grouped contiguously. In response, optical switching network 108 changes the order from the first spatial order to a second spatial order at the outputs. In this example, the optical switching network 108 outputs light having wavelengths corresponding to wavelength set A at a first subset of the plurality of outputs and light having wavelengths corresponding to wavelength set B at a second subset of the plurality of outputs in accordance with the second spatial order. In the second spatial order of FIG. 2B, wavelengths corresponding to wavelength set A alternate with wavelengths corresponding to wavelength set B.

In other embodiments, the first spatial order (at the inputs of optical switching network 108) involves wavelengths corresponding to wavelength set A alternating with wavelengths corresponding to wavelength set B, and the second spatial order (at the outputs of optical switching network 108) involves wavelengths corresponding to wavelength set A and wavelengths corresponding to wavelength set B being grouped contiguously. Other orders are possible.

The orders of wavelength sets discussed above are referred to as “spatial orders” in that they relate to the physical location of the ports (whether inputs or outputs) of optical switching network 108. As further shown in FIG. 2C, the inputs and the outputs of optical switching network 108 are organized sequentially: the i^{th} input is physically located between the i−1^{th} input and the i+1^{th} input, and the i^{th} output is physically located between the i−1^{th} output and the i+1^{th} output. Optical switching network 108 is said to have changed (or remapped) the spatial order of the wavelength sets from a first spatial order to a second spatial order if there is at least one i for which the wavelength set present at the ii input differs from the wavelength set present at the i^{th} output.

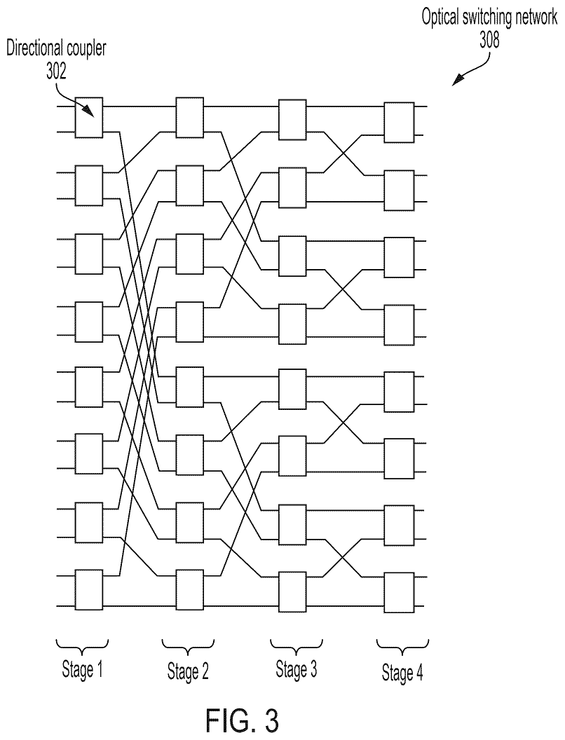

FIG. 3 is a block diagram illustrating an example implementation of optical switching network 108, in accordance with some embodiments. In this example, optical switching network 308 includes a plurality of directional couplers 302 arranged in a plurality of stages including four stages: stage 1, stage 2, stage 3 and stage 4. The directional couplers of stage 2 are coupled to outputs of the directional couplers of stage 1 and to inputs of the directional couplers of stage 3. Similarly, the directional couplers of stage 3 are coupled to outputs of the directional couplers of stage 2 and to inputs of the directional couplers of stage 4. As shown in FIG. 3, optical switching network 308 includes four stages, which equals Log₂(N) stages, where N(=16) represents the number of inputs and outputs of optical switching network 308. Each directional coupler in this example includes two inputs and two outputs, and may operate as a 3 dB coupler in each direction (although other coupling ratios are possible). The directional coupler may be passive (whereby the coupling ratios are fixed) or active (whereby the coupling ratios are variable, for example using the thermo-optic effect or the electro-optic effect). Other optical switching networks may be implemented using couplers other than 2×2 directional couplers, including for example multi-mode interferometers (MMI) and arrayed waveguide arrays (AWG).

It should also be noted that the optical switching network of FIG. 3 is implemented as a butterfly architecture. Other embodiments may include optical switching networks implemented as Benes networks. A Benes network may include a pair of butterfly networks arranged in a back-to-back configuration, with 2×Log₂(N)−1 stages. However, butterfly networks are preferable over Benes networks because they are more compact.

FIG. 4 is a block diagram illustrating an example implementation of transceiver 110, in accordance with some embodiments. Transceiver 410 includes a transmitter (TX) bank 400 and a receiver (RX) bank 401. An input waveguide 402 couples light from an output of optical switching network 108 to TX bank 400. In this example, light carried by waveguide 402 has wavelengths corresponding to wavelength set A. TX bank 400 includes one optical encoder 404 for each wavelength included as part of wavelength set A. In this example, TX bank 400 includes eight optical encoders 404 and wavelength set A includes eight wavelengths. The optical encoder may be implemented using resonant modulators, as shown in FIG. 4. More specifically, in this example, optical encoders 404 are implemented using micro-ring modulators (MRM), although other types of resonant modulators are also possible, including micro-disk modulators. Each resonant modulators is tuned to exhibit a resonant wavelength that corresponds to a respective wavelength of wavelength set A. In this way, each resonant modulator encodes light at a particular wavelength with data without affecting the other wavelengths, consistent with WDM communication schemes. Light emitted from transceiver 410 via TX output waveguide 412 has wavelengths corresponding to the wavelengths of set A, where each channel is encoded with data. TX output waveguide 412 is coupled to an input of optical combiner 116.

Similarly, RX bank 401 includes one optical drop filter 406 and one detector 408 for each wavelength included as part of a wavelength set. It should be noted that the wavelength set received at RX bank 401 may match wavelength set A or may be a different wavelength set (e.g., wavelength set B). In other words, the transmitter and receiver of a particular transceiver are not constrained to operate at the same wavelength set (although they may operate at the same wavelength set in some embodiments). Light is coupled to RX bank 401 through RX input waveguide 414. In this example, RX bank 401 includes eight drop filters and eight detectors, one for each wavelength of the incoming set. Drop filter 406 may be implemented using resonant filters, as shown in FIG. 4. In this example, drop filter 406 is implemented using a second order filter having a pair of evanescently coupled micro-ring resonators. Second order filters exhibit a flatter response relative to first order filers, thereby increasing the filter's spectral selectivity. Each drop filter is tuned to exhibit a resonant wavelength that corresponds to a respective wavelength of the incoming wavelength set. In this way, each drop filter extracts light from RX input waveguide 414 at a particular wavelength without affecting the other wavelengths, consistent with WDM communication schemes. Detectors 408 convert the optical signals provided by the respective drop filters into the electrical domain.

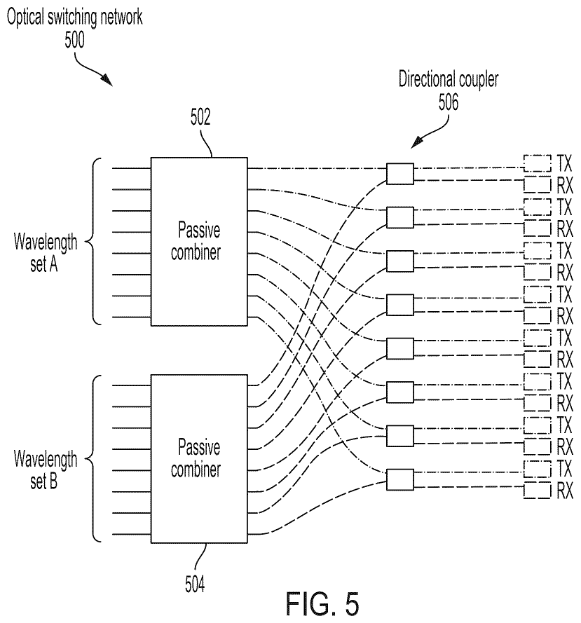

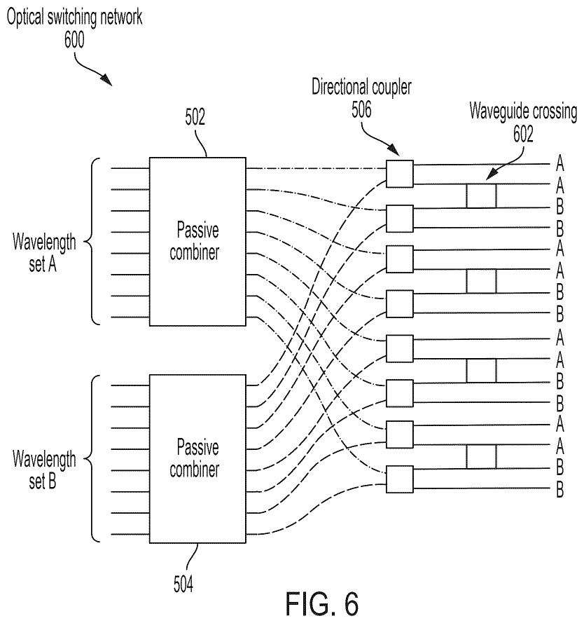

FIGS. 5-6 are block diagrams of additional examples of optical switching networks, in accordance with some embodiments. The scheme depicted in FIG. 5 is said to perform 2-port swapping in that it changes the order of the wavelength sets from AAAAAAAABBBBBBBB to ABABABABABABABAB. The scheme depicted in FIG. 6 is said to perform 4-port swapping in that it changes the order of the wavelength sets from AAAAAAAABBBBBBBB to AABBAABBAABBAABB.

Referring first to the scheme of FIG. 5, optical switching network 500 includes a passive combiner for each wavelength set received at the optical switching network. In this example, the optical switching network receives two wavelength sets: wavelength set A and wavelength set B.

Accordingly, optical switching network 500 includes two passive combiners, identified with numerals 502 and 504, respectively. Passive combiner 502 operates on input light having wavelengths corresponding to wavelength set A, while passive combiner 504 operates on input light having wavelengths corresponding to wavelength set B. Passive combiners 502 and 504 distribute each of the wavelengths received at their inputs across all their outputs. For example, passive combiner 502 may receive light having a wavelength corresponding to λ₁ at the first input, light having a wavelength corresponding to λ₂ at the second input . . . light having a wavelength corresponding to λ₈ at the eight input. Passive combiner 502 may distribute the received light so that each output of passive combiner 502 outputs light having wavelengths corresponding to each of the received wavelengths (λ₁, λ₂, λ₃, λ₄, λ₅, λ₆, λ₇, and λ₈). Similarly, passive combiner 504 may receive light having a wavelength corresponding to λ₉ at the first input, light having a wavelength corresponding to λ₁₀ at the second input . . . light having a wavelength corresponding to λ₁₆ at the eight input. Passive combiner 504 may distribute the received light so that each output of passive combiner 504 outputs light having wavelengths corresponding to each of the received wavelength (λ₉, λ₁₀, λ₁₀, λ₁₂, λ₁₃, λ₁₄, λ₁₅, and λ₁₆).

Optical switching network 500 further includes a set of directional couplers 506. Each directional coupler has two inputs. One input receives light having wavelengths corresponding to wavelength set A from a respective output of passive combiner 502. The other input receives light having wavelengths corresponding to wavelength set B from a respective output of passive combiner 504. Each directional coupler 506 has two outputs. One output is coupled to the transmitter (TX) of a respective transceiver 110. The other output is coupled to the receiver (RX) of a respective transceiver 110. In this configuration, each transmitter receives light having wavelengths corresponding to wavelength set A and each receiver receives light having wavelengths corresponding to wavelength set B. As a result, light traveling in a channel 130 on opposite directions have different wavelengths.

Optical switching network 600, illustrated in FIG. 6, is similar to optical switching network 500 in that it includes the same arrangement of passive combiners 502 and 504 and directional couplers 506. In addition, however, optical switching network 600 includes waveguides crossings 602, which allow the network to swap the location of some of the outputs. As shown, each directional coupler has an output that is coupled to a waveguide crossing 602 and an output that is not coupled to any waveguide crossings.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

The definitions, as defined and used herein, should be understood to control over dictionary definitions, definitions in documents incorporated by reference and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some case and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately,” “substantially,” and “about” may be used to mean within ±20% of a target value in some embodiments. The terms “approximately,” “substantially,” and “about” may include the target value.

Use of ordinal terms such as “first,” “second,” “third,” etc., in the claims to modify a claim element does not by itself connotate any priority, precedence, or order of one claim element over another or the temporal order in which acts of a method are performed, but are used merely as labels to distinguish one claim element having a certain name from another claim element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The terms “couple,” “coupled,” and “coupling,” when used in connection with optical components, are to be interpreted broadly to include both direct and indirect coupling. Two optical components are considered directly coupled if there are no intervening components between them. In contrast, two optical components are considered indirectly coupled if there is at least one intervening component between them, provided that the intervening component does not alter the general nature of the interaction between the optical components.

What is claimed is:

1. A photonic integrated circuit (PIC), comprising:
an optical switching network having a plurality of inputs and a plurality of outputs, wherein the optical switching network is configured to, in response to receiving light having wavelengths corresponding to a first wavelength set at a first subset of the plurality of inputs and light having wavelengths corresponding to a second wavelength set at a second subset of the plurality of inputs in accordance with a first spatial order, output light having wavelengths corresponding to the first wavelength set at a first subset of the plurality of outputs and light having wavelengths corresponding to the second wavelength set at a second subset of the plurality of outputs in accordance with a second spatial order, wherein the first spatial order differs from the second spatial order; and
a plurality of optical transmitters coupled to the plurality of outputs of the optical switching network, each optical transmitter of the plurality of optical transmitters being configured to encode light received from the respective output with data.

2. The PIC of claim 1, wherein the plurality of inputs comprise N inputs and the plurality of outputs comprise N outputs.

3. The PIC of claim 2, further comprising a first plurality of optical sources and a second plurality of optical sources, each optical source of the first plurality being configured to emit light having wavelengths corresponding to the first wavelength set and each optical source of the second plurality being configured to emit light having wavelengths corresponding to the second wavelength set, wherein the first plurality of optical sources are coupled to the first subset of the N inputs of the optical switching network and the second plurality of optical sources are coupled to the second subset of the N inputs of the optical switching network in accordance with the first spatial order.

4. The PIC of claim 3, wherein each optical source of the first and second pluralities of optical sources is disposed outside the PIC.

5. The PIC of claim 1, wherein:
in the first spatial order, wavelengths corresponding to the first wavelength set and wavelengths corresponding to the second wavelength set are grouped contiguously, and
in the second spatial order, wavelengths corresponding to the first wavelength set alternate with wavelengths corresponding to the second wavelength set.

6. The PIC of claim 1, wherein:
in the first spatial order, wavelengths corresponding to the first wavelength set alternate with wavelengths corresponding to the second wavelength set, and
in the second spatial order, wavelengths corresponding to the first wavelength set and wavelengths corresponding to the second wavelength set are grouped contiguously.

7. The PIC of claim 1, wherein:
a first optical transmitter of the plurality of optical transmitters that is coupled to an output of the first subset of the plurality of outputs comprises a first plurality of resonant modulators, each resonant modulator of the first plurality of resonant modulators being tuned to a respective wavelength of the first wavelength set.

8. The PIC of claim 7, wherein:
a second optical transmitter of the plurality of optical transmitters that is coupled to an output of the second subset of the plurality of outputs comprises a second plurality of resonant modulators, each resonant modulator of the second plurality of resonant modulators being tuned to a respective wavelength of the second wavelength set.

9. The PIC of claim 8, wherein the resonant modulators of the first plurality of resonant modulators and the resonant modulators of the second plurality of resonant modulators comprise ring-based resonant modulators.

10. The PIC of claim 1, wherein the optical switching network comprises a plurality of directional couplers arranged in a plurality of stages including first, second and third stages, wherein the directional couplers of the second stage are coupled to outputs of the directional couplers of the first stage and to inputs of the directional couplers of the third stage.

11. The PIC of claim 10, wherein the plurality of inputs comprise N inputs and the plurality of outputs comprise N outputs, and wherein the plurality of stages comprise Log₂(N) stages.

12. The PIC of claim 1, wherein the optical switching network is arranged in accordance with a butterfly architecture.

13. A photonic integrated circuit (PIC), comprising:
an optical switching network having N inputs, N outputs, a plurality of directional couplers arranged in a plurality of stages including first, second and third stages, wherein the directional couplers of the second stage are coupled to outputs of the directional couplers of the first stage and to inputs of the directional couplers of the third stage, wherein the plurality of stages comprise Log₂(N) stages, and
a plurality of optical transmitters coupled to the N outputs of the optical switching network, each optical transmitter of the plurality of optical transmitters being configured to encode light received from the respective output with data.

14. The PIC of claim 13, further comprising a first plurality of optical sources and a second plurality of optical sources, each optical source of the first plurality being configured to emit light having wavelengths corresponding to a first wavelength set and each optical source of the second plurality being configured to emit light having wavelengths corresponding to a second wavelength set, wherein the first plurality of optical sources are coupled to a first subset of the N inputs of the optical switching network and the second plurality of optical sources are coupled to a second subset of the N inputs of the optical switching network in accordance with a first spatial order.

15. The PIC of claim 14, wherein the plurality of directional couplers are configured to output light having wavelengths corresponding to the first wavelength set at a first subset of the N outputs and light having wavelengths corresponding to the second wavelength set at a second subset of the N outputs in accordance with a second spatial order, wherein the first spatial order differs from the second spatial order.

16. The PIC of claim 15, wherein:
in the first spatial order, wavelengths corresponding to the first wavelength set and wavelengths corresponding to the second wavelength set are grouped contiguously, and
in the second spatial order, wavelengths corresponding to the first wavelength set alternate with wavelengths corresponding to the second wavelength set.

17. The PIC of claim 14, wherein:
a first optical transmitter of the plurality of optical transmitters that is coupled to an output of the first subset of the N outputs comprises a first plurality of resonant modulators, each resonant modulator of the first plurality of resonant modulators being tuned to a respective wavelength of the first wavelength set, and
a second optical transmitter of the plurality of optical transmitters that is coupled to an output of the second subset of the N outputs comprises a second plurality of resonant modulators, each resonant modulator of the second plurality of resonant modulators being tuned to a respective wavelength of the second wavelength set.

18. A method for operating a photonic integrated circuit (PIC), comprising:
using an optical switching network having a plurality of inputs and a plurality of outputs to, in response to receiving light having wavelengths corresponding to a first wavelength set at a first subset of the plurality of inputs and light having wavelengths corresponding to a second wavelength set at a second subset of the plurality of inputs in accordance with a first spatial order, output light having wavelengths corresponding to the first wavelength set at a first subset of the plurality of outputs and light having wavelengths corresponding to the second wavelength set at a second subset of the plurality of outputs in accordance with a second spatial order, wherein the first spatial order differs from the second spatial order; and
using a plurality of optical transmitters, coupled to the plurality of outputs of the optical switching network and co-integrated with the optical switching network on the PIC, to encode light received from respective outputs with data.

19. The method of claim 18, further comprising:
using a first plurality of optical sources to emit light having wavelengths corresponding to the first wavelength set and using a second plurality of optical sources to emit light having wavelengths corresponding to the second wavelength set, wherein the first plurality of optical sources are coupled to a first subset of the plurality of inputs of the optical switching network and the second plurality of optical sources are coupled to a second subset of the plurality of inputs of the optical switching network in accordance with the first spatial order.

20. The method of claim 18, wherein:
in the first spatial order, wavelengths corresponding to the first wavelength set and wavelengths corresponding to the second wavelength set are grouped contiguously, and
in the second spatial order, wavelengths corresponding to the first wavelength set alternate with wavelengths corresponding to the second wavelength set.
